(19) United States
(12) Patent Application Publication
(10) Pub. No.: US 2023/0041561 A1
(43) Pub. Date: Feb. 9, 2023

(54) Systems and Methods for a Hydrokinetic Micro Powerplant

(71) Applicants: Robert J Evans, Scottsdale, AZ (US); Lisa Marie Evans, Scottsdale, AZ (US)

(72) Inventors: Robert J Evans, Scottsdale, AZ (US); Lisa Marie Evans, Scottsdale, AZ (US); Joseph Pepe Elijio Velasquez, Tempe, AZ (US); Joseph M Barrett, Tempe, AZ (US); Katherine Dunn, San Diego, CA (US)

(73) Assignees: Robert J Evans, Scottsdale, AZ (US); Lisa Marie Evans, Scottsdale, AZ (US)

(21) Appl. No.: 17/381,080

(22) Filed: Jul. 20, 2021

(51) Int. Cl. F03B 13/10; F03B 3/04; F03B 11/00; F03B 17/06; F01D 25/28

(52) U.S. Cl. CPC F03B 13/10; F03B 3/04; F03B 11/00; F03B 17/061; F01D 25/28

(57) ABSTRACT

A power generation system anchored to a hydraulic arm, capable of pivoting up or down to optimize power generation based upon the present conditions of the flowing body of water. The turbines are augmented by diffusers to improve fluid flow and power generation. The overall design is easily built, installed, and maintained, providing easy power to homes without a need to connect to a public grid, and safety measures are affixed to prevent undesired items from entering the turbine propellers.

### BACKGROUND

### 1. Technical Field

Aspects of this document relate generally to systems and methods for hydrokinetic generation of electrical power.

### 2. Description of Related Art

With fossil fuel-based energy on the decline, alternative power generation has been in high demand. Among other methods, the generation of electric power using flowing water is of interest, due to its wide availability and the potential for virtually unlimited “clean energy.”

Hydroelectric power generation is generally well-known. Prior art contains numerous references to systems which generate electric power using a rotor to capture the natural flow of rivers or other bodies of water.

However, these systems leave room for improved design. For example, existing models are often unable to easily adjust to accommodate changes in a river as it changes in speed in volume. Failure to adjust to changing river conditions results in suboptimal capture of the kinetic potential energy of the river.

Yet other designs in the prior art utilize rotors affixed to tethered, mobile floatation devices which automatically move with the flow of water. These designs solve the problem of adaptation to the changes in river flow, but introduce another problem: the freedom given to such rotor systems allows them to turn in response to fluid drag forces, shifting the rotor to a suboptimal capture angle. This, again, reduces overall efficiency.

So as to reduce the complexity and length of the Detailed Specification, and to fully establish the state of the art in certain areas of technology, Applicant(s) herein expressly incorporate(s) by reference all of the following materials identified in each numbered paragraph below.

WIPO Patent WO 2007/139406 A1 describes a device which converts the energy of flowing water using a submerged rotor connected with a rotor system.

CN Patent CN202209247U describes a system for generating hydroelectric power using turbines suspended on a river.

CN Patent CN209261726U describes a system for generating hydroelectric power using floatation elements.

US Patent Application US 2010/0140946 A1 describes a system for generating hydroelectric power on a river using a wheel and a floating body.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY

The present invention provides among other things a system and method for efficiently generating electrical power using a flowing body of water. The system as disclosed is capable of optimizing power production as the conditions of the body of water change over time.

Implementations of an electrical power generation system may comprise a plurality of turbines, each turbine comprising a propeller coupled to an electric generator and a first portion of a hydraulic arm configured to extend over a flowing body of water and coupled to a plurality of pontoons, the first portion of the hydraulic arm further comprising an anchor arm that couples the plurality of turbines to the first portion of the hydraulic arm. The system may further comprise a second portion of the hydraulic arm coupled to the first portion of the hydraulic arm, the second portion of the hydraulic arm further coupled to an on-shore anchor point, wherein the first and second portions of the hydraulic arm comprise a conductive strip electrically connected to the plurality of turbines and an on-shore transformer.

Particular aspects may comprise one or more of the following features. The on-shore anchor point may form a first pivot point for the second portion of the hydraulic arm. The first portion of the hydraulic arm and the second portion of the hydraulic arm may be coupled via a second pivot point. The system may further comprise a plurality of protection buoys upstream from the plurality of turbines. The protection buoys may be coupled to an anchor that is configured to couple to a bottom of the flowing body of water. The propeller may be housed in a diffuser comprising a conical frustum. At least a portion of the turbines from among the plurality of turbines may further comprise debris protection bars upstream from the propeller of the turbine. The on-shore transformer may be configured to couple to a plurality of stone gabions.

Implementations of a method of electrical power generation may comprise positioning a first portion of a hydraulic arm that is coupled to a plurality of pontoons over a flowing body of water, coupling the first portion of the hydraulic arm to a second portion of the hydraulic arm, and coupling the second portion of the hydraulic arm to an on-shore anchor point. The method may further comprise coupling a plurality of turbines in series to the first portion of the hydraulic arm, each turbine comprising a propeller coupled to an electric generator, the plurality of turbines coupled to the first portion of the hydraulic arm via an anchor arm, transferring an electric current generated the electric generator in response to water turning the propellor of the turbine to a conductive strip coupled to the first and second portions of the hydraulic arm, and transferring the electric current from the conductive strip to an on-shore transformer.

Particular aspects may comprise one or more of the following features. The on-shore anchor point may form a first pivot point for the second portion of the hydraulic arm. The first portion of the hydraulic arm and the second portion of the hydraulic arm may be coupled via a second pivot point. The method may further comprise preventing external interference with one or more of the electrical generators using a plurality of protection buoys positioned upstream from the plurality of turbines. The method may further comprise coupling the plurality of protection buoys to an anchor coupled to a bottom of the flowing body of water. The propeller may be housed in a diffuser comprising a conical frustum. The turbines may further comprise debris protection bars upstream from the propeller. The on-shore transformer may be configured to couple to a plurality of stone gabions.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or Claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for,” and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION, DRAWINGS, and CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a top view of an embodiment of a hydrokinetic micro powerplant.

FIG. 2 depicts an isometric view of a plurality of diffuser-augmented turbines coupled to hydraulic arms and pontoons.

FIG. 3 depicts a side view of a diffuser-augmented turbine.

FIG. 4 depicts a front view of a diffuser-augmented turbine.

FIG. 5 depicts an isometric view of a diffuser-augmented turbine.

FIG. 6 depicts an isometric view of an embodiment of a hydrokinetic micro powerplant comprising a plurality of protection buoys.

FIG. 7 depicts a downstream view of an embodiment of a hydrokinetic micro powerplant comprising a plurality of diffuser-augmented turbines coupled to hydraulic arms and pontoons.

FIG. 8 depicts a cross-sectional view along Section A of FIG. 1.

FIG. 9 depicts a cross-sectional view along Section B of FIG. 7.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

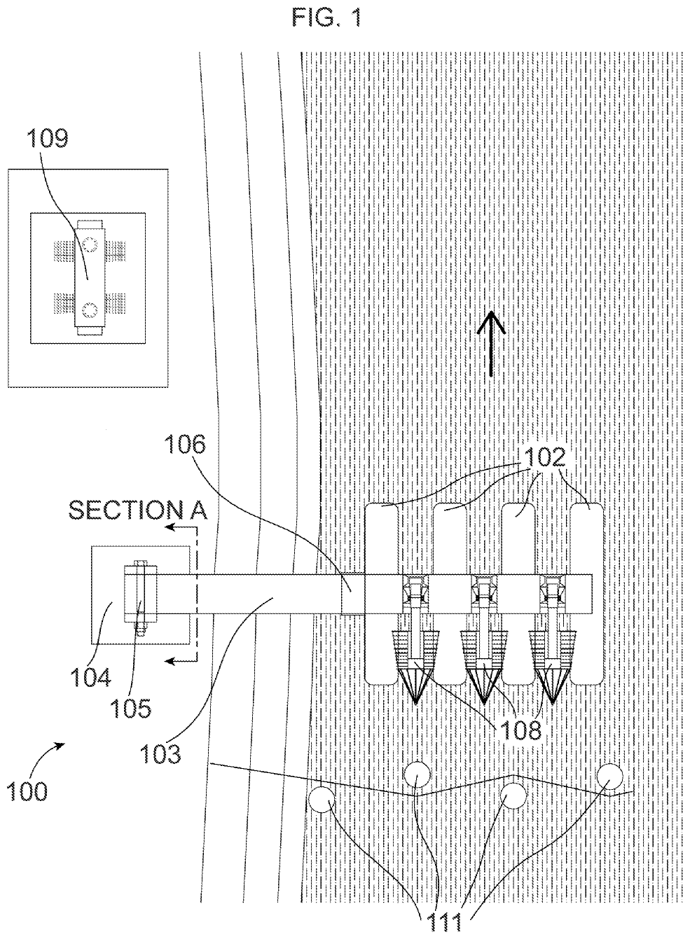

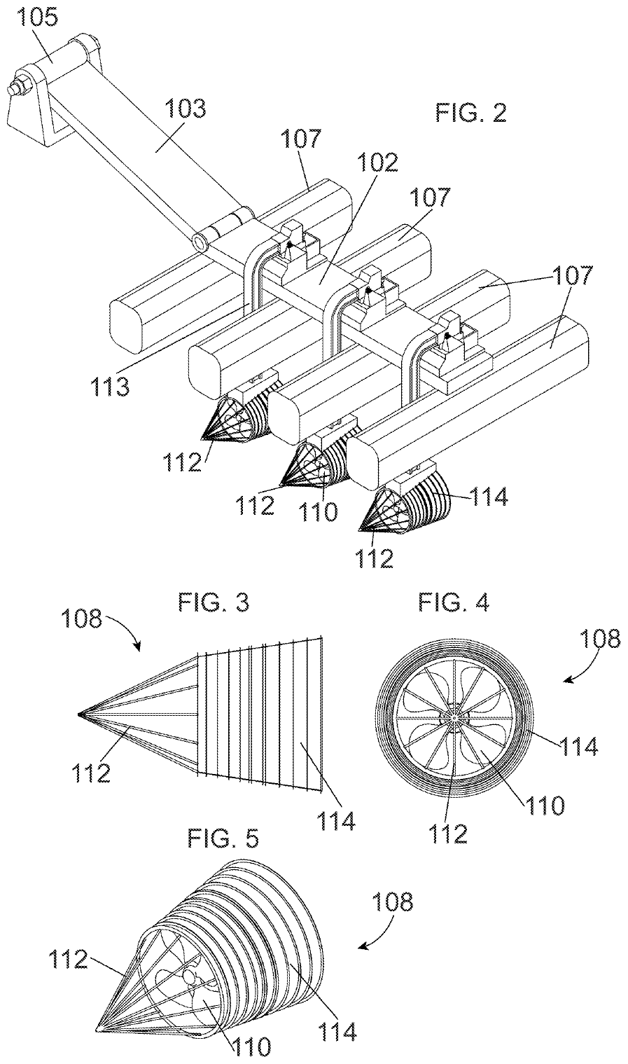

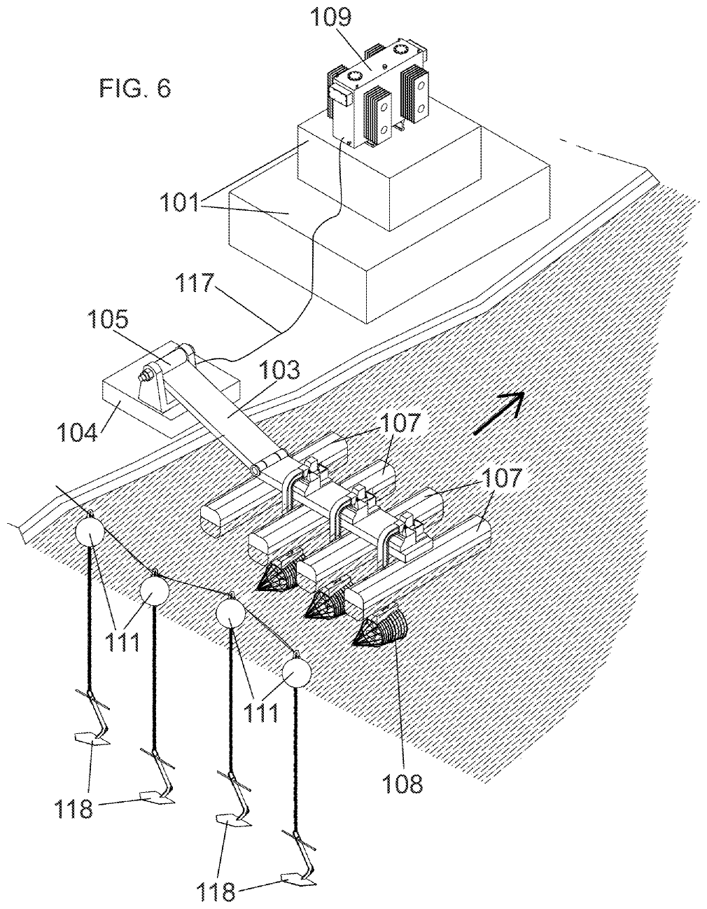

FIG. 1 is a top view of one embodiment of a power generation system 100; FIG. 6 is a perspective view of the same. In the depicted embodiment, electric power is generated by a unidirectional water flow through a body of water or other liquid such as, by non-limiting example, a river, stream, or lake. In some embodiments, the power generation system may be adapted to be used in a stream of effluent. As shown in FIG. 1, water passes through a plurality of turbines 108 submerged in the flowing body of water. FIG. 6 displays how each turbine 108 from among the plurality of turbines 108 may be coupled to a first portion of a hydraulic arm 102 via one or more anchor arms 113. The one or more anchor arms 113 may be substantially curved to couple to the first portion of the hydraulic arm 102 and may be positioned between one or more pontoons 107 which may be coupled to the first portion of the hydraulic arm 102 or which may be freely floating or otherwise loosely anchored to the first portion of the hydraulic arm 102 such as with a chain, cable, rope, or other coupling mechanism. Alternatively, in some embodiments, one or more turbines 108 may be coupled to the first portion of the hydraulic arm 102 via a chain, cable, or rope. As shown here, the system may comprise a plurality of pontoons 107, which, in this embodiment, collectively serve to provide stability and support to the system 100. In some embodiments, the system 100 may further comprise one or more protection buoys 111 located upstream from the turbines 108 which may be configured to be anchored to the bed of the body of water by one or more buoy anchors 118 to prevent wildlife, humans, and other debris from contacting propellors 110 of the turbines 108.

FIG. 3 depicts a side view of one embodiment of a turbine 108; FIG. 4 depicts a front view of the same; FIG. 5 depicts a perspective view of the same. As shown in FIG. 5, in this embodiment, the turbine propeller 110 is housed in a diffuser 114 to improve fluid flow by increasing the water velocity within the turbine 108 through the propeller 110 thereby increasing the energy potential of the system 100. In this embodiment, debris protection bars 112 are coupled to the diffuser housing to prevent aquatic wildlife or other undesired objects from entering the turbine 108. While the diffuser 114 may comprise any suitable shape, as shown here, by non-limiting example, the diffuser 114 may at least partially comprise a conical frustum.

The illustrated turbine 108 design has greater potential for energy generation as compared to a traditional wind turbine and also provides the added benefit of having a relatively low installation cost when compared to that of conventional hydropower technologies. These advantages, combined with a relatively short implementation time as well as uninterrupted power generation in the presence of constant water current flow may make the disclosed system ideal for generating electrical power in isolated communities such as those in rural areas.

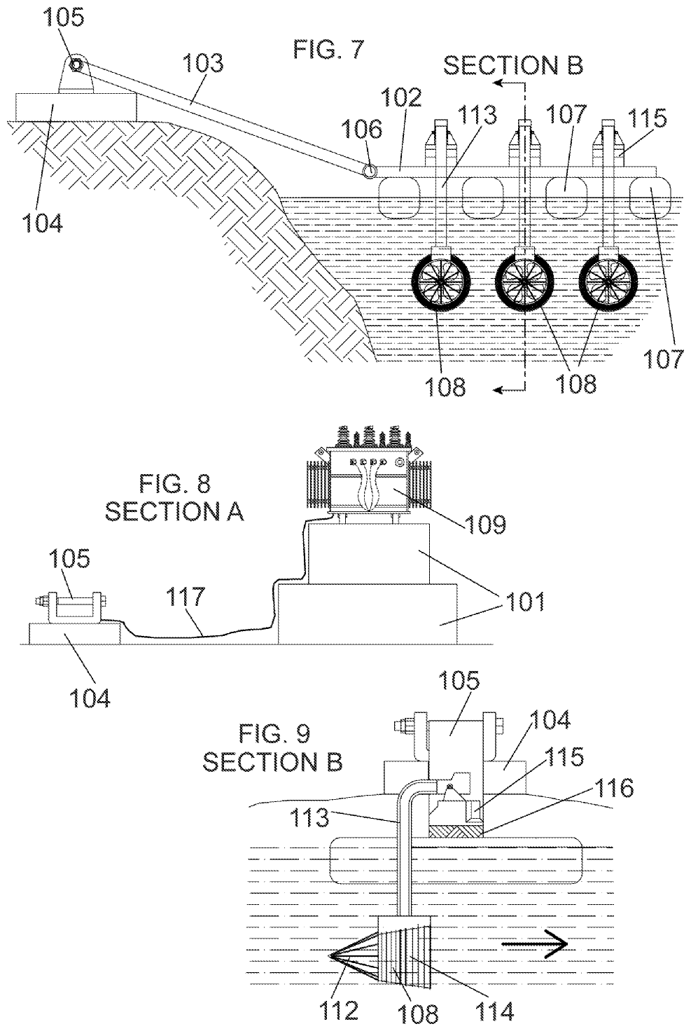

FIG. 7 shows a front view of an implementation of the off-shore components for one embodiment of the system and FIG. 9 provides a cross-sectional view of Section B. As shown in FIG. 7, in this embodiment the second portion of the hydraulic arm 102 is coupled to an on-shore anchor point 104 at a first pivot point 105. Further, in this embodiment the first portion of the hydraulic arm 102 may be coupled to the second portion of the hydraulic arm 103 at a second pivot point 106. The inclusion of these pivot points 105, 106 allows the hydraulic arm to move vertically to optimize the location of the turbines 108 within the moving body of water.

Electric power is created in the generator 115 by the rotation of the turbines 108 and this power is transmitted via a conducting strip 116 shown in FIG. 9, which runs through the first portion of the hydraulic arm 102 and second portion of the hydraulic arm 103 as depicted in FIG. 7. This electric current proceeds from the hydraulic arm through an electric cord 117, as depicted in FIG. 6.

FIG. 8 shows a cross-sectional view of an implementation of on-shore components according to one embodiment. As shown in FIG. 8, a transformer 109 receives electrical current via the electrical cord 117. In this embodiment, the transformer 109 is placed upon stone gabions 101, however, any other suitably stable structure may also be used to anchor the transformer 109. Among other benefits, the stone gabions may also improve the system's flood-resistance which may be particularly valuable in areas prone to flooding.

### Example 1

The U.S. Department of Energy defines a river current turbine as a “low pressure run-of the-river ultra-low head turbine that will operate at the equivalent of less than 0.2 m of head.” In such turbines, the flowing water kinetic energy is transferred to a rotating energy converter which eventually is transformed into electricity using a generator.

The resulting generated power (P) and converted energy are expressed as:

$$P = ( \frac{1}{8} ) * ρ * π * {D}^{2} * {v}^{3} * C o s ( θ ) * C p * η g * η t r \qquad Equation 1$$

Where:

P: Power (W)

T: Turbine diameter (ft, m)

v: velocity (ft/s, m/s)

Cp: Power coefficient

ng: Generator efficiency

ntr: Transmission efficiency; and

p: Density of the water (lbs/ft³, kg/m³)

While any appropriate number of turbines 108 may be used, as illustrated in the exemplary embodiments of this disclosure, it may be preferable to employ three SMART DUO-type turbines with high efficiencies for power generation in rivers. Exemplary technical specifications and design variables are presented below in Table 1:

TABLE 1
Technical specifications and design variables

| Parameter | Units | Turbine 1 | Turbine 2 | Turbine 3 |
|---|---|---|---|---|
| P | kW | 1.80 | 1.80 | 1.80 |
| ρ | kg/m³ | 1000 | 1000 | 1000 |
| PI | π | 3.14 | 3.14 | 3.14 |
| ν | m/s | 2.8 | 2.8 | 2.8 |
| θ | ° | 0 | 0 | 0 |
| Cp | — | 0.65 | 0.65 | 0.65 |
| ηg | % | 0.95 | 0.95 | 0.95 |
| ηtr | % | 0.95 | 0.95 | 0.95 |
| D | m | 0.60 | 0.60 | 0.60 |

An average energy demand calculation was performed to estimate the number of rural houses that a plant having such an exemplary configuration may be able to supply. The final number of users will vary based on the specific conditions of flow and velocity of the site where the model will be implemented.

For Example 1, the energy used for supply calculations is based on average daily consumption in a rural house in Colombia, South America. These energy demand calculations require re-estimation for different locales.

### Number of Houses Supplied

The number of houses supplied under this example of the disclosed power plant is calculated using an average energy demand in rural areas equal to 0.253 kW-day. The calculation of the number of houses supplied is performed by using the following equation:

$$\# Houses = \frac{P}{{E}_{h}} \qquad Equation 2$$

Where:

P: Total power Generated with the turbines (W, kW); and

Eh: Energy demand for one rural house (kW day).

Replacing the values in Equation 2 with the variables presented in Table 1, we obtain the number of houses that the plant could supply as follows:

$$\# Houses = \frac{1.8 kW * 3 Turbines}{0.253 kW - day} \\ \# Houses = 21 Houses$$

Table 2, below, provides approximated ranges of power generated at different velocities assuming SMART DUO-type of turbine efficiencies. The final power calculations before implementing the disclosed power plant will be re-estimated for the specific site. This table is intended only for generic use.

TABLE 2
Power generated and number of houses supplied at different velocities

| | | | | | | | | | | | | | |
|---|---|---|---|---|---|---|---|---|---|---|---|---|---|
| 3 | Velocity (m/s) | 1.0 | 1.2 | 1.5 | 1.8 | 2.0 | 2.2 | 2.4 | 2.5 | 2.8 | 3.0 | 3.2 | 3.5 |
| Turbines | Power (kW) | 0.25 | 0.43 | 0.83 | 1.43 | 1.97 | 2.62 | 3.40 | 3.84 | 5.40 | 6.64 | 8.06 | 10.55 |
| Installed | # of Houses | 1 | 2 | 3 | 6 | 8 | 10 | 13 | 15 | 21 | 26 | 32 | 42 |
| 2 | Velocity (m/s) | 1.0 | 1.2 | 1.5 | 1.8 | 2.0 | 2.2 | 2.4 | 2.5 | 2.8 | 3.0 | 3.2 | 3.5 |
| Turbines | Power (kW) | 0.16 | 0.28 | 0.55 | 0.96 | 1.31 | 1.75 | 2.27 | 2.56 | 3.60 | 4.43 | 5.37 | 7.03 |
| Installed | # of Houses | 1 | 1 | 2 | 4 | 5 | 7 | 9 | 10 | 14 | 18 | 21 | 28 |
| 1 | Velocity (m/s) | 1.0 | 1.2 | 1.5 | 1.8 | 2.0 | 2.2 | 2.4 | 2.5 | 2.8 | 3.0 | 3.2 | 3.5 |
| Turbine | Power (kW) | 0.08 | 0.14 | 0.28 | 0.48 | 0.66 | 0.87 | 1.13 | 1.28 | 1.80 | 2.21 | 2.69 | 3.52 |
| Installed | # of Houses | 0 | 1 | 1 | 2 | 3 | 3 | 4 | 5 | 7 | 9 | 11 | 14 |

In places where the description above refers to particular implementations of systems and methods for a hydrokinetic micro powerplant, it should be readily apparent that a number of modifications may be made without departing from the spirit thereof and that these implementations may be applied to other to systems and methods for a hydrokinetic micro powerplant.

I/We claim:

1. An electrical power generation system comprising:
a plurality of turbines, each turbine comprising a propeller coupled to an electric generator;
a first portion of a hydraulic arm configured to extend over a flowing body of water and coupled to a plurality of pontoons, the first portion of the hydraulic arm further comprising an anchor arm that couples the plurality of turbines to the first portion of the hydraulic arm; and
a second portion of the hydraulic arm coupled to the first portion of the hydraulic arm, the second portion of the hydraulic arm further coupled to an on-shore anchor point, wherein the first and second portions of the hydraulic arm comprise a conductive strip electrically connected to the plurality of turbines and an on-shore transformer.

2. The system of claim 1, wherein the on-shore anchor point forms a first pivot point for the second portion of the hydraulic arm.

3. The system of claim 2, wherein the first portion of the hydraulic arm and the second portion of the hydraulic arm are coupled via a second pivot point.

4. The system of claim 1, wherein the system further comprises a plurality of protection buoys upstream from the plurality of turbines.

5. The system of claim 4, wherein the protection buoys are coupled to an anchor that is configured to couple to a bottom of the flowing body of water.

6. The system of claim 1, wherein the propeller is housed in a diffuser comprising a conical frustum.

7. The system of claim 1, wherein at least a portion of the turbines from among the plurality of turbines further comprise debris protection bars upstream from the propeller of the turbine.

8. The system of claim 1, wherein the on-shore transformer is configured to couple to a plurality of stone gabions.

9. A method of electrical power generation comprising:
positioning a first portion of a hydraulic arm that is coupled to a plurality of pontoons over a flowing body of water;
coupling the first portion of the hydraulic arm to a second portion of the hydraulic arm;
coupling the second portion of the hydraulic arm to an on-shore anchor point;
coupling a plurality of turbines in series to the first portion of the hydraulic arm, each turbine comprising a propeller coupled to an electric generator, the plurality of turbines coupled to the first portion of the hydraulic arm via an anchor arm;
transferring an electric current generated by the electric generators in response to water turning the propellor of the turbine to a conductive strip coupled to the first and second portions of the hydraulic arm; and
transferring the electric current from the conductive strip to an on-shore transformer.

10. The method of claim 9, wherein the on-shore anchor point forms a first pivot point for the second portion of the hydraulic arm.

11. The method of claim 10, wherein the first portion of the hydraulic arm and the second portion of the hydraulic arm are coupled via a second pivot point.

12. The method of claim 9, further comprising preventing external interference with one or more of the electrical generators using a plurality of protection buoys positioned upstream from the plurality of turbines.

13. The method of claim 12, further comprising coupling the plurality of protection buoys to an anchor coupled to a bottom of the flowing body of water.

14. The method of claim 9, wherein the propeller is housed in a diffuser comprising a conical frustum.

15. The method of claim 9, wherein the turbines further comprise debris protection bars upstream from the propeller.

16. The method of claim 9, wherein the on-shore transformer is configured to couple to a plurality of stone gabions.
